(19) United States
(12) Patent Application Publication
(10) Pub. No.: US 2012/0237050 A1
(43) Pub. Date: Sep. 20, 2012

(54) SOUND PICKUP DEVICE

(75) Inventor: Maki Akasaka, Osaka (JP)

(73) Assignee: Panasonic Corporation, Osaka (JP)

(21) Appl. No.: 13/252,166

(22) Filed: Oct. 3, 2011

(30) Foreign Application Priority Data
Mar. 16, 2011 (JP) 2011-057498
Jun. 16, 2011 (JP) 2011-133780

(51) Int. Cl. H04R 1/10

(52) U.S. Cl. 381/74

(57) ABSTRACT

A sound pickup device comprises a microphone, a connection terminal, and a controller. The microphone is configured to picks up sound and produces audio data. The connection terminal is configured to be connected a headphone. The controller is configured to receive a change of instructions regarding the input sensitivity of the microphone in response to the headphone being connected to the connection terminal.

### CROSS-REFERENCE TO RELATED APPLICATIONS

This application claims priority under 35 U.S.C. §119 to Japanese Patent Application No. 2011-057498, filed on Mar. 16, 2011 and Japanese Patent Application No. 2011-133780, filed on Jun. 16, 2011. The entire disclosure of Japanese Patent Application No. 2011-057498 and Japanese Patent Application No. 2011-133780 are hereby incorporated herein by reference.

### BACKGROUND

1. Technical Field

The technology disclosed herein relates to a sound pickup device, and more particularly relates to a sound pickup device with which the input sensitivity of a microphone can be set.

2. Background Information

In Japanese Laid-Open Patent Application S61-168169, there is disclosed a karaoke device. The karaoke device is designed so that microphone signals are mixed with the reproduced signal of a reproduction medium, amplified, and emitted from a speaker. With this karaoke device, in a state in which a headphone is connected to a headphone terminal, the signal mixed as mentioned above can be freely adjusted so that the user can listen to the headphone at the proper volume.

### SUMMARY

However, it has been discovered that whenever a conventional sound pickup device is used to pick up sound with a microphone, as discussed above, if the input sensitivity of the microphone can be adjusted at any time, there is the risk that the user involuntarily changes the input sensitivity.

Accordingly, one object of the technology disclosed herein is to provide a sound pickup device in which the audio picked up by a microphone can be confirmed while the input sensitivity of the microphone can be easily changed, but when the audio picked up by the microphone cannot be confirmed, the likelihood that the input sensitivity of the microphone will be incorrectly adjusted is reduced.

In accordance with one aspect of the technology disclosed herein, a sound pickup device is provided that includes a microphone, a connection terminal, and a controller. The microphone is configured to pick up sound and produce audio data. The connection terminal is configured to be connected to a headphone, and the controller is configured to receive a change of instructions regarding the input sensitivity of the microphone in response to the headphone being connected to the connection terminal.

These and other features, aspects and advantages of the technology disclosed herein will become apparent to those skilled in the art from the following detailed description, which, taken in conjunction with the annexed drawings, discloses a preferred and example embodiments of the present invention.

### BRIEF DESCRIPTION OF DRAWINGS

Referring now to the attached drawings which form a part of this original disclosure:

FIG. 1 is an oblique view of a digital video camera 100 and a headphone 500;

FIG. 2 is a block diagram of the configuration of the digital video camera 100;

FIG. 3 is a block diagram of the configuration of a controller 180;

FIG. 4 is a schematic diagram showing what is displayed on a display monitor 220 in input sensitivity setting mode;

FIG. 5 is a flowchart showing the display operation of the display monitor 220 in imaging mode;

FIG. 6A is a schematic diagram of the display transition of the display monitor 220 in imaging mode; and

FIG. 6B is a schematic diagram of the display transition of the display monitor 220 in imaging mode.

### DETAILED DESCRIPTION OF EMBODIMENTS

An Embodiment 1 of applying the present invention to a digital video camera will be described through reference to the drawings.

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### Embodiment 1

### 1-1. Summary

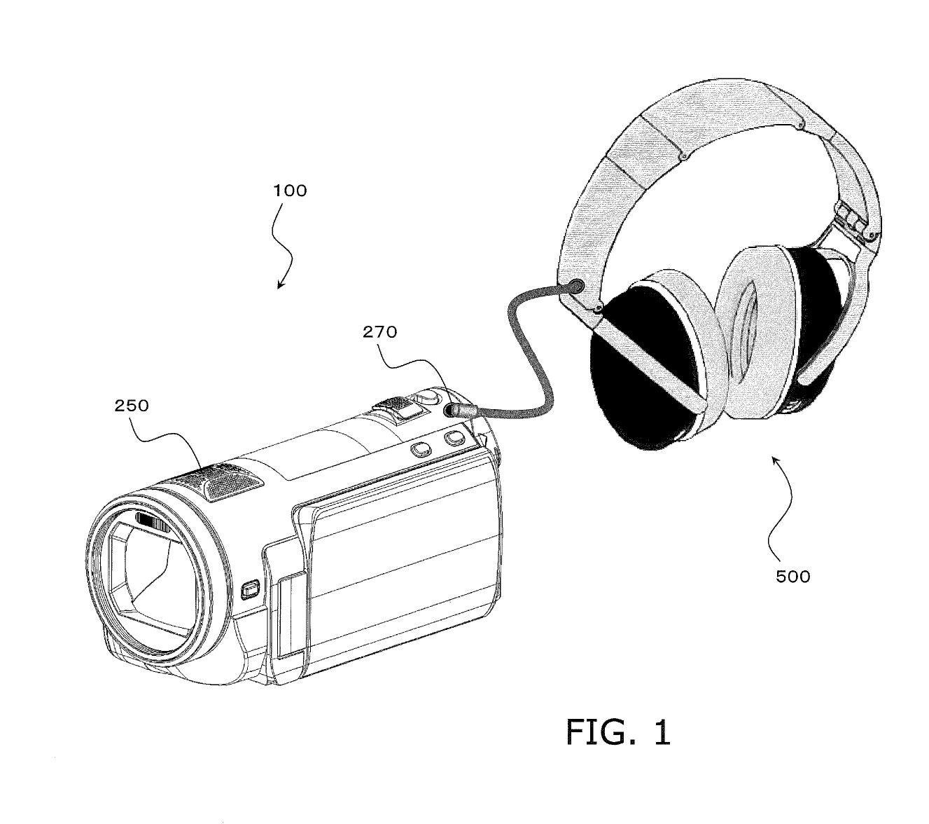

A summary of the digital video camera 100 pertaining to this embodiment will be given through reference to FIG. 1. FIG. 1 is an oblique view of the digital video camera 100 and a headphone 500. The digital video camera 100 comprises a microphone 250 and a headphone terminal 270. The jack of the headphone 500 can be connected to the headphone terminal 270. In a state in which the jack of the headphone 500 has been connected to the headphone terminal 270, audio corresponding to the audio data picked up by the microphone 250 and processed in the digital video camera 100 can be outputted.

The digital video camera 100 allows the input sensitivity of the microphone 250 to be adjusted. When the headphone 500 is connected, the digital video camera 100 allows the reception of a change instruction for the input sensitivity of the microphone 250. Consequently, the user of the digital video camera 100 can confirm the audio picked up by the microphone 250 while easily changing the input sensitivity of the microphone 250. Also, in the event that the user of the digital video camera 100 cannot confirm the audio picked up by the microphone 250, it is less likely that the input sensitivity of the microphone 250 will be incorrectly adjusted.

### 1-2. Configuration of Digital Video Camera 100

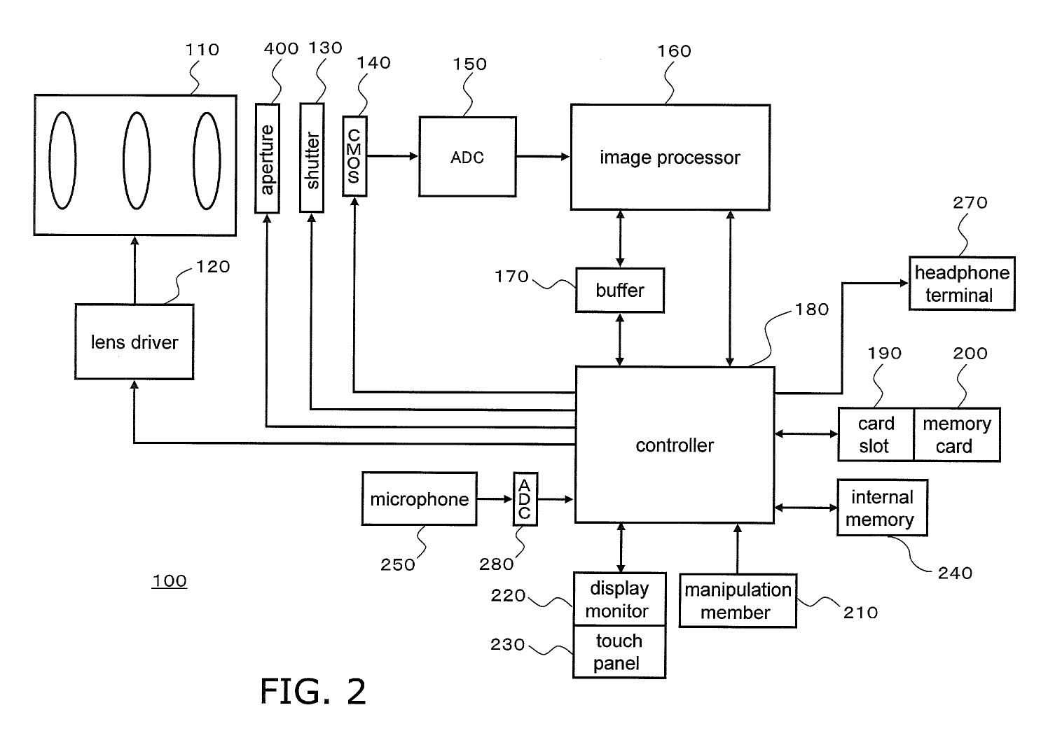

The electrical configuration of the digital video camera 100 pertaining to this embodiment will be described through reference to FIG. 2. FIG. 2 is a block diagram of the configuration of the digital video camera 100. The digital video camera 100 uses a CMOS image sensor 140 (an example of the “imaging means” of the present invention) to capture a subject image formed by an optical system 110 consisting of one or more lenses. The image data produced by the CMOS image sensor 140 is subjected to various processing by an image processor 160, and stored on a memory card 200. The configuration of the digital video camera 100 will now be described in detail.

The optical system 110 is made up of a zoom lens and a focus lens. The subject image can be enlarged or reduced by moving the zoom lens along the optical axis. The focus of the subject image can be adjusted by moving the focus lens along the optical axis.

A lens driver 120 drives the various lenses included in the optical system 110. The lens driver 120 includes a zoom motor for driving the zoom lens, and a focus motor for driving the focus lens, for example.

An aperture 400 adjusts the amount of light transmitted by adjusting the size of an opening, either automatically or according to the user's settings.

A shutter 130 is a means for blocking light transmitted by the CMOS image sensor 140.

The CMOS image sensor 140 captures the subject image formed by the optical system 110, and produces image data. The CMOS image sensor 140 performs various operations, such as exposure, transfer, and electronic shutter.

An A/D converter 150 converts the analog image data produced by the CMOS image sensor 140 into digital image data.

The image processor 160 subjects the image data produced by the CMOS image sensor 140 to various processing, and produces image data for display on the display monitor 220, or produces image data for storage on the memory card 200. For example, the image processor 160 subjects the image data produced by the CMOS image sensor 140 to gamma correction, white balance correction, scratch correction, and various other processing. The image processor 160 also compresses the image data produced by the CMOS image sensor 140 in a compression format that conforms to the H.264 standard or the MPEG2 standard, for example. The image processor 160 can be a DSP, a microprocessor, or the like.

The controller 180 is a control means for controlling the entire digital video camera. The controller 180 can be a semiconductor element or the like. The controller 180 may be constituted by hardware alone, or by a combination of hardware and software. The controller 180 can be a microprocessor or the like.

Here, the controller 180 can set between three different modes: imaging mode, input sensitivity setting mode, and reproduction mode. The “imaging mode” is a mode in which it is possible to receive a recording start instruction for capturing image data from the user. In the description that follows, a state prior to receiving the recording start instruction and in imaging mode is called an “imaging standby state,” and a state after receiving the recording start instruction and in imaging mode is called an “imaging state.” The “input sensitivity setting mode” is a mode in which the input sensitivity of the microphone 250 can be adjusted. In this embodiment, a recording start instruction from the user cannot be received in input sensitivity setting mode, but the present invention is not limited to this. The “reproduction mode” is a mode in which an image corresponding to the image data read from the memory card 200 can be displayed on the display monitor 220.

In this embodiment, the controller 180 can adjust the input sensitivity of the microphone 250 not only when the mode is set to input sensitivity setting mode, but also in imaging mode when a specific condition is met. The specific condition is that the headphone 500 (see FIG. 1) be connected to the headphone terminal 270 (an example of the “connection terminal” pertaining to the present invention). The functional configuration and operation of the controller 180 will be discussed below.

A buffer 170 functions as a working memory for the image processor 160 and the controller 180. The buffer 170 can be a DRAM, a ferroelectric memory, or the like, for example.

A card slot 190 allows the memory card 200 to be inserted and removed. The card slot 190 can be mechanically and electrically connected to the memory card 200. A flash memory, ferroelectric memory, or the like is included in the interior of the memory card 200, and the memory card 200 can store data of image files produced by the image processor 160 and so forth.

An internal memory 240 is constituted by a flash memory, a ferroelectric memory, or the like. The internal memory 240 stores control programs and the like for controlling the entire digital video camera 100.

A manipulation member 210 (an example of the “manipulation member” of the present invention) is the name given to refer collectively to user interfaces that receive input from the user. The manipulation member 210 is a cross key, enter button, or the like that receive input from the user, for example. In this embodiment, the manipulation member 210 has a mode selector dial (not shown) that receives the selection of either the imaging mode, the input sensitivity setting mode, or the reproduction mode. The mode selector dial outputs to the controller 180 a mode signal indicating the selected mode. The manipulation member 210 also has a recording start button (not shown) used to issue a recording start instruction for image data in imaging mode. The recording start button outputs to the controller 180 a recording start signal indicating that the recording start button has been pressed.

The display monitor 220 (an example of the “display means” of the present invention) can display an image corresponding to the image data produced by the CMOS image sensor 140 (a through image), or an image corresponding to the image data read from the memory card 200. The display monitor 220 can also display various menu screens or the like for changing various settings of the digital video camera 100.

A touch panel 230 is provided on the display monitor 220. When the user touches some position on the touch panel 230, the touch panel 230 sends the controller 180 coordinate information indicating the position touched by the user.

The microphone 250 picks up sounds and produces audio data. The microphone 250 picks up 5.1-channel surround sound, and can produce 5.1-channel audio data. An A/D converter 280 converts the analog audio data produced by the microphone 250 into digital audio data.

The headphone terminal 270 is a terminal for connecting the headphone 500 or another output device. When the headphone 500 or another output device is connected to the headphone terminal 270, the controller 180 outputs audio to the headphone 500 or other output device.

### 1-3. Functional Configuration of Controller 180

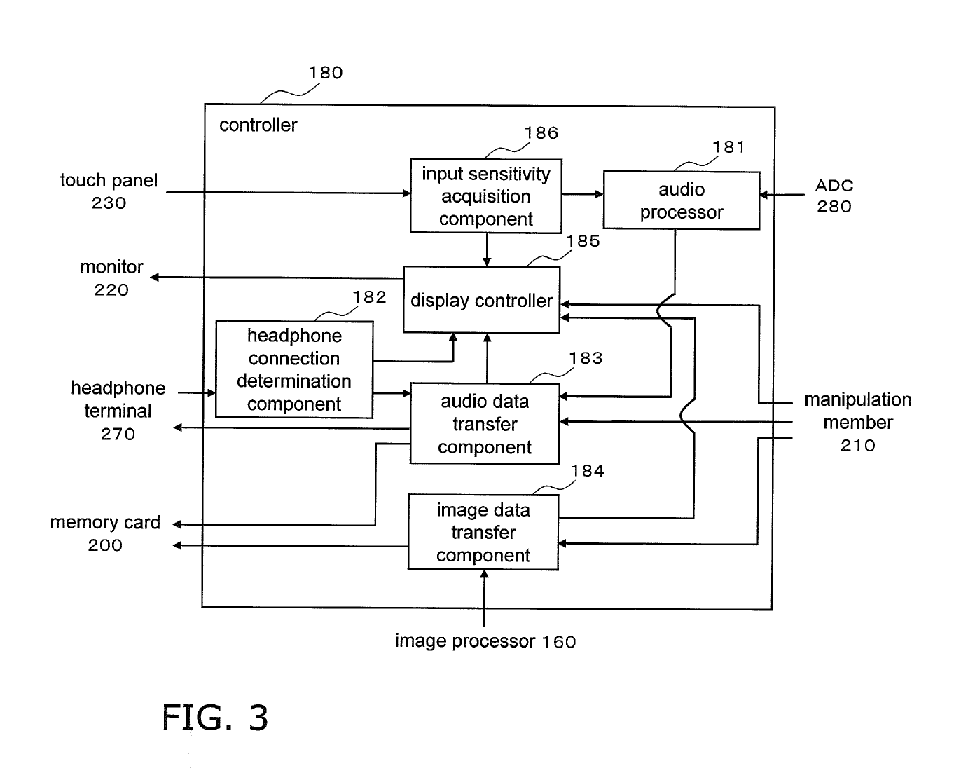

FIG. 3 is a block diagram of the functional configuration of the controller 180 pertaining to this embodiment. As shown in FIG. 3, the controller 180 comprises an audio processor 181, a headphone connection determination component 182, an audio data transfer component 183, an image data transfer component 184, a display controller 185, and an input sensitivity acquisition component 186.

The audio processor 181 performs various processing on the digital audio data produced by the A/D converter 280. For example, the audio processor 181 subjects audio data to gain adjustment processing on the basis of the input sensitivity currently set at the input sensitivity acquisition component 186, and thereby produces processed audio data. The audio processor 181 performs gain adjustment processing on the basis of changed input sensitivity if the input sensitivity has been changed at the input sensitivity acquisition component 186. The audio processor 181 also subjects acquired audio data to encoding processing or decoding processing. The audio processor 181 outputs the audio data that has undergone the various processing to the audio data transfer component 183.

The headphone connection determination component 182 decides whether or not the headphone 500 has been connected to the headphone terminal 270. The headphone connection determination component 182 sends the decision result to the audio data transfer component 183 and the display controller 185.

The audio data transfer component 183 outputs to the display controller 185 data indicating the audio volume on the basis of the audio data outputted from the audio processor 181. The audio data transfer component 183 also outputs audio data to the headphone terminal 270 when a notification to the effect that the headphone 500 has been connected to the headphone terminal 270 is acquired from the headphone connection determination component 182. The audio data transfer component 183 also sends audio data to the memory card 200 in response to a recording start signal from the manipulation member 210.

The image data transfer component 184 outputs the image data outputted from the image processor 160 to the display controller 185. The image data transfer component 184 also sends image data to the memory card 200 in response to a recording start signal from the manipulation member 210.

The display controller 185 controls what is displayed on the display monitor 220 in response to a mode signal from the manipulation member 210.

More specifically, when the mode signal indicates the input sensitivity setting mode, the display controller 185 acquires the input sensitivity currently set for the microphone 250 from the input sensitivity acquisition component 186, and acquires the audio data currently being picked up by the microphone 250 from the audio data transfer component 183. The display controller 185 then displays on the display monitor 220 an icon indicating the input sensitivity, an icon indicating the volume of the audio that was picked up, and an icon for changing the input sensitivity. Here, the display controller 185 can display an image (through image) corresponding to the image data sent from the image data transfer component 184, along with various icons, on the display monitor 220.

Meanwhile, when the mode signal indicates the imaging mode, the display controller 185 displays a through image on the display monitor 220 regardless of whether there is an imaging standby state or an imaging state. Here, if the display controller 185 acquires from the headphone connection determination component 182 a notification to the effect that the headphone 500 has been connected to the headphone terminal 270, then the display controller 185 displays on the display monitor 220 an icon indicating the input sensitivity and an icon for changing the input sensitivity. The operation of the display controller 185 and what is displayed on the display monitor 220 will be discussed below.

If a changed input sensitivity has been inputted from the input sensitivity acquisition component 186, the display controller 185 changes the display of the icon indicating a changed input sensitivity.

The input sensitivity acquisition component 186 decides whether or not coordinate information corresponding to the icon for changing the input sensitivity has been sent from the touch panel 230. If coordinate information indicating the icon for changing the input sensitivity has been sent, the input sensitivity acquisition component 186 changes the input sensitivity according to this coordinate information. The input sensitivity acquisition component 186 outputs the changed input sensitivity to the audio processor 181 and the display controller 185.

### 1-4. Operation of Controller 180

(1) Setting Input Sensitivity in Input Sensitivity Setting Mode

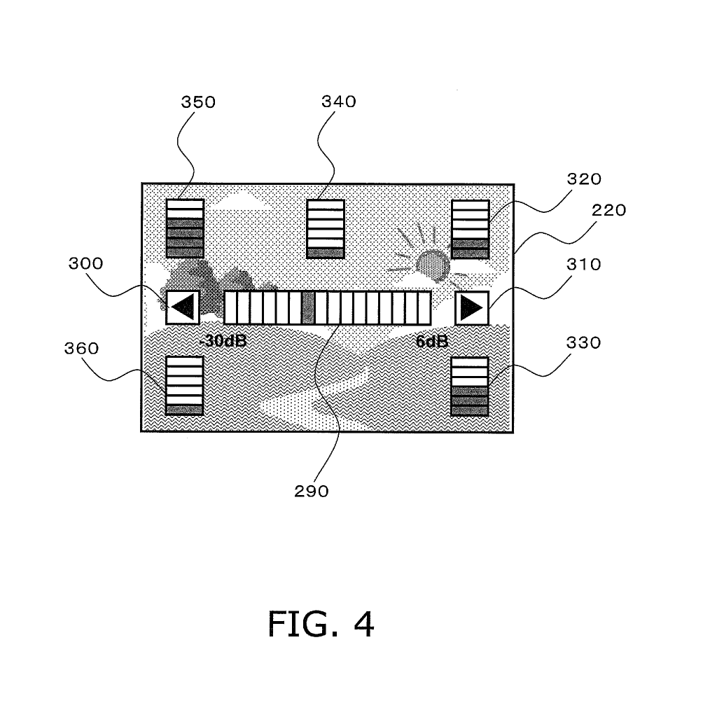

The input sensitivity setting mode will be described through reference to FIG. 4. FIG. 4 is a schematic diagram showing what is displayed on the display monitor 220 in input sensitivity setting mode. The user turns the mode selector dial, which is part of the manipulation member 210, to set the digital video camera 100 to input sensitivity setting mode. When the input sensitivity setting mode has been set, the controller 180 begins display of the various icons shown in FIG. 4 on the display monitor 220.

An input sensitivity display icon 290 is a bar icon indicating the input sensitivity currently set for the microphone 250. Each block on the input sensitivity display icon 290 indicates a measure of input sensitivity. In this embodiment, the input sensitivity can be set over a range of from −30 to 6 dB. The block that is colored in on the input sensitivity display icon 290 indicates the currently set input sensitivity.

An input sensitivity change icon 300 and an input sensitivity change icon 310 are icons for changing the input sensitivity of the microphone 250. The user touches the input sensitivity change icon 300 or the input sensitivity change icon 310 to change the setting for input sensitivity of the microphone 250. For example, when the user touches the input sensitivity change icon 310, the colored portion of the input sensitivity display icon 290 moves one block to the right, and the input sensitivity of the microphone 250 goes up by one level. When the user touches the input sensitivity change icon 300, the colored portion of the input sensitivity display icon 290 moves one block to the left, and the input sensitivity of the microphone 250 goes down one level.

An audio level icon 320, an audio level icon 330, an audio level icon 340, an audio level icon 350, and an audio level icon 360 are icons indicating the volume of the audio currently being picked up by the microphone 250. These icons show the volume of the audio being picked up by the various microphones on the five channels of the microphone 250. Each block of each icon shows the level for audio volume being picked up by that microphone. A state in which all the blocks of an icon are colored in is a state in which audio of the maximum volume that can be picked up by the microphone is being picked up. A state in which none of the blocks of an icon are colored in is a state in which the microphone is not picking up any audio.

Thus, with the digital video camera 100, in a state in which the input sensitivity setting mode has been set, the input sensitivity display icon 290, the input sensitivity change icon 300, and the input sensitivity change icon 310 are displayed on the display monitor 220, and the audio level icons 320 to 360 are also displayed. Displaying the audio level icons 320 to 360 allows the user to set the input sensitivity of the microphone 250 while visually checking the levels of audio volume currently being picked up by the various microphones of the microphone 250, even if the headphone 500 has not been connected to the digital video camera 100.

(2) Setting Input Sensitivity in Imaging Mode

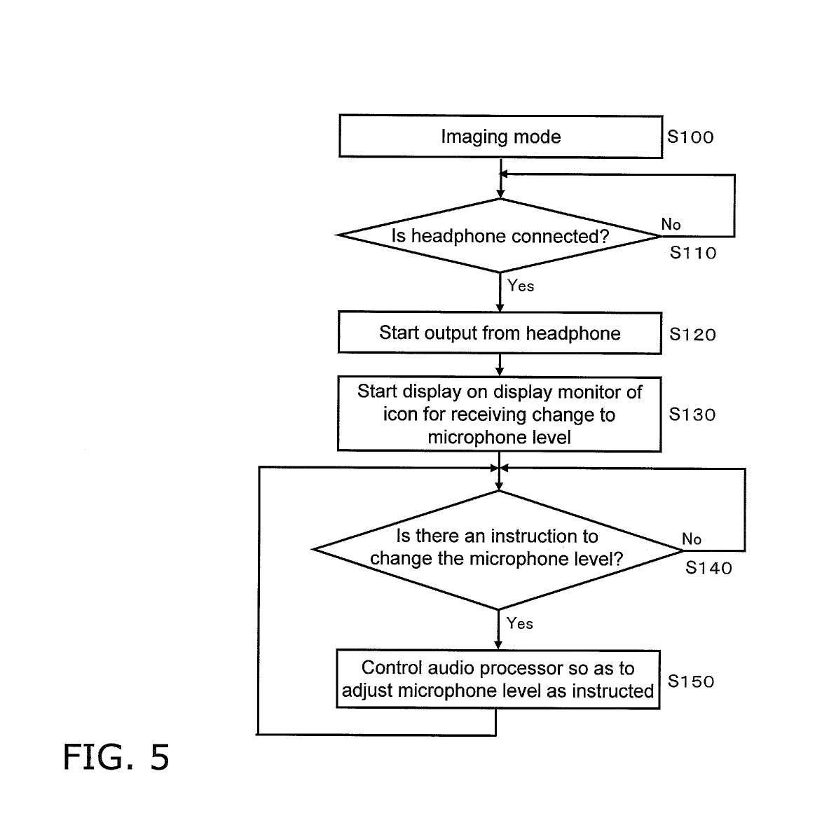

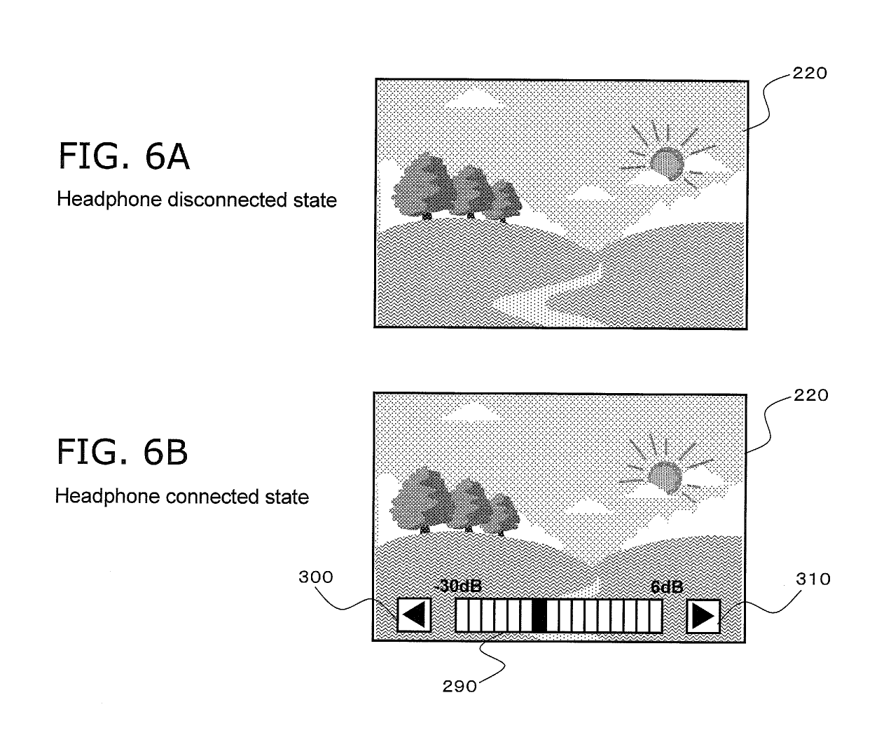

As discussed above, the user can adjust the input sensitivity of the microphone 250 when a specific condition is met, even if the digital video camera 100 is set to imaging mode. In this section, we will refer to FIGS. 5 and 6 to describe the setting of the input sensitivity of the microphone 250 when imaging mode has been set. FIG. 5 is a flowchart illustrating the display operation of the display monitor 220 in imaging mode. FIG. 6A and FIG. 6B are schematic diagrams of the display transition of the display monitor 220 in imaging mode.

The user can set the digital video camera 100 to imaging mode by turning the mode selector dial of the manipulation member 210 (S100). In this state, the display monitor 220 displays an image (a through image) such as that shown in FIG. 6A. That is, in this state the display monitor 220 does not display any icons or the like for adjusting the input sensitivity of the microphone 250. When the digital video camera 100 is set to imaging mode, the controller 180 decides whether or not the headphone 500 has been connected to the headphone terminal 270 (S110).

If it is decided that the headphone 500 has been connected, the controller 180 begins the output to the headphone 500 of audio corresponding to the audio data produced through the microphone 250 (S120). When the output of audio to the headphone 500 begins, the controller 180 controls the display monitor 220 so as to start the display of the input sensitivity display icon 290, the input sensitivity change icon 300, the input sensitivity change icon 310, and other icons related to the input sensitivity of the microphone 250, as shown in FIG. 6B (S130).

Once the display monitor 220 starts displaying icons related to input sensitivity, the controller 180 decides whether or not there is a change instruction for the input sensitivity of the microphone 250 from the user (S140). More specifically, the controller 180 decides whether or not coordinate information indicating the input sensitivity change icon 300 or the input sensitivity change icon 310 has been sent from the touch panel 230.

If it is decided that there is an instruction to change the input sensitivity, the controller 180 changes the setting for input sensitivity to the instructed level (S150).

If the mode of the digital video camera 100 is changed to a mode other than imaging mode, the digital video camera 100 leaves the control of the flowchart shown in FIG. 5.

In FIG. 5, a case in which the headphone 500 is first connected and then disconnected is not shown, but in this case, the controller 180 controls the display monitor 220 so as to stop the display of the input sensitivity display icon 290, the input sensitivity change icon 300, and the input sensitivity change icon 310 (that is, controls the display monitor 220 so that the display will be as in FIG. 6A), and waits until the headphone 500 is again connected (return to step S110).

### 1-5. Action and Effect

Thus, the digital video camera 100 pertaining to this embodiment comprises the microphone 250 that picks up sound, the headphone terminal 270 that allows a headphone 500 to be connected, and the controller 180 that allows the receipt of a change instruction for the input sensitivity of the microphone 250 when a headphone 500 is connected to the headphone terminal 270. Consequently, with the digital video camera 100, the user can easily change the input sensitivity of the microphone 250 while checking the audio being picked up by the microphone 250, but when the audio picked up by the microphone 250 cannot be confirmed, the likelihood that the input sensitivity of the microphone will be incorrectly adjusted is reduced.

That is, with the digital video camera 100 pertaining to this embodiment, when the headphone 500 has been connected, even if the imaging mode has been set, it is still possible to receive a change instruction for the input sensitivity of the microphone 250. This is because when the headphone 500 has been connected, the user can change the input sensitivity of the microphone 250 while using the headphone 500 to check the audio being picked up by the microphone 250, which is extremely convenient. On the other hand, if the headphone 500 has not been connected, the user cannot check the audio being picked up by the microphone 250. In this case, if it were possible to change the input sensitivity of the microphone 250, the user might end up setting the input sensitivity of the microphone 250 to an unintended level. In view of this, with the digital video camera 100, when the imaging mode has been set, and the headphone 500 has not been connected, setting of the input sensitivity of the microphone 250 is restricted.

The digital video camera 100 pertaining to this embodiment further comprises the CMOS image sensor 140 for capturing a subject image and producing image data, and a recording start button (part of the manipulation member 210) for receiving an instruction to the memory card 200 to start recording the image data produced by the CMOS image sensor 140, and the input sensitivity of the microphone 250 can be set into the input sensitivity setting mode in which the input sensitivity of the microphone 250 can be changed and the recording start button does not receive a recording start instruction, and into an imaging mode in which the recording start button can receive a recording start instruction. If the input sensitivity setting mode has been set, then the display monitor 220 displays the audio level icons 320 to 360 indicating the volume of the audio corresponding to the audio data recorded to the memory card 200, and if the imaging mode has been set, the display monitor 220 does not display the audio level icons 320 to 360 indicating the volume of the audio corresponding to the audio data recorded to the memory card 200. The reason for this constitution will now be described. In imaging mode, the main goal of the user is to perform imaging while checking the image that is actually being captured. When the imaging mode has been set, it is best to avoid displaying too many icons on the display monitor 220. In view of this, when the imaging mode has been set, the display monitor 220 does not display the audio level icons 320 to 360 indicating the volume of the audio corresponding to the audio data recorded to the memory card 200. Consequently, when the camera is set to a mode whose basic purpose is not imaging, such as the input sensitivity setting mode, the display monitor 220 can be used to full potential for setting the input sensitivity, whereas when the camera is set to a mode that requires that priority be given to visual checking of the image being captured, such as in imaging mode, then the display of icons on the display monitor 220 is kept low.

### Other Embodiments

Embodiment 1 was described above as an embodiment of the present invention, but the present invention is not limited to or by this embodiment. Other embodiments of the present invention shall therefore be compiled and described in this section.

In the above embodiment, the CMOS image sensor 140 was given as an example of an imaging means, but the imaging means is not limited to this. For example, the imaging means may be constituted by a CCD image sensor or an NMOS image sensor.

Also, the image processor 160 and the controller 180 may be constituted by a single semiconductor chip, or by separate semiconductor chips.

In Embodiment 1, the microphone 250 was a 5.1-channel microphone, but does not necessarily have to have this constitution. For instance, it may be a one-channel microphone, a two-channel microphone, or a 7.1-channel microphone. In other words, it may be any microphone that picks up sound.

Also, in Embodiment 1, if the digital video camera 100 is set to imaging mode and the headphone 500 has been connected to the digital video camera 100, then the input sensitivity display icon 290, the input sensitivity change icon 300, and the input sensitivity change icon 310 were always displayed on the display monitor 220. But this configuration is not necessarily required. For example, if there has been no change instruction for the input sensitivity of the microphone 250 within a specific length of time since the headphone 500 was connected, the display of the input sensitivity display icon 290, the input sensitivity change icon 300, and the input sensitivity change icon 310 may be halted, or just the display of the input sensitivity display icon 290 may be halted and the display of the input sensitivity change icon 300 and the input sensitivity change icon 310 left in place, or just the display of the input sensitivity display icon 290 may be left and the display of the input sensitivity change icon 300 and the input sensitivity change icon 310 may be halted. This further reduces the number of icons displayed on the display monitor 220.

Also, in Embodiment 1, the setting of the input sensitivity of the microphone 250 was carried out through the touch panel 230, but this configuration is not necessarily required. For example, a button for setting the input sensitivity may be physically provided. In this case, when a headphone has been connected to the digital video camera, the button input for setting the input sensitivity is active, but when no headphone is connected, the button input for setting the input sensitivity is inactive.

Also, in Embodiment 1, the input sensitivity display icon 290 was displayed on the display monitor 220, but this configuration is not necessarily required. For example, a light emission button indicating the input sensitivity may be physically provided. This further reduces the number of icons displayed on the display monitor 220.

Also, in Embodiment 1, as long as the headphone 500 was connected in imaging mode, the controller 180 did not display the audio level icons 320 to 360 regardless of whether there was an imaging standby state or an imaging state, but the present invention is not limited to this. The controller 180 may display the audio level icons 320 to 360 in an imaging standby state even though the headphone 500 is connected in imaging mode.

Thus, the present invention of course includes various embodiments and the like that are not discussed herein. Therefore, the technological scope of the present invention is not limited to just the specific inventions pertaining to the appropriate claims from the descriptions given above.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention, should be interpreted relative to the sound pickup device.

The term “configured” as used herein to describe a component, section or part of a device includes hardware and/or software that is constructed and/or programmed to carry out the desired function.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A sound pickup device comprising:
a microphone configured to pick up sound and produce audio data;
a connection terminal configured to be connected to a headphone; and
a controller configured to receive a change of instructions regarding the input sensitivity of the microphone in response to the headphone being connected to the connection terminal.

2. The sound pickup device according to claim 1, further comprising:
an imaging unit configured to capture a subject image and produce image data;
a reception unit configured to receive instructions directing the reception unit to start recording the image data and the audio data to a storage medium; and
a display unit configured to display an image corresponding to the image data, wherein
the controller includes an input sensitivity setting mode that manages the input sensitivity of the microphone, the controller being configured to control the display unit to display an audio level icon that indicates the volume of the audio data when the controller is set to the input sensitivity setting mode and not display the audio level icon when the image data is recorded to the storage medium.

3. The sound pickup device according to claim 2, wherein
the image data and the audio data are not recorded to the storage medium if the controller is set to the input sensitivity setting mode, even if the reception unit has received instructions to start recording.

4. The sound pickup device according to claim 2, wherein
the controller includes an imaging mode that permits recording of the image data and the audio data to the storage medium in response to instructions received by the reception unit, the audio level icon not being displayed on the display unit if the controller is set to the imaging mode.

5. The sound pickup device according to claim 1, wherein
upon receiving the change of instructions, the controller changes the input sensitivity of the microphone according to the change of instructions and produces processed audio data by subjecting the audio data to processing based on the changed input sensitivity.

6. The sound pickup device according to claim 5, wherein
the controller is configured to record the processed audio data to a storage medium.

7. The sound pickup device according to claim 5, wherein
the controller is configured to output the processed audio data to the connection terminal when the headphone is connected to the connection terminal.

8. The sound pickup device according to claim 6, wherein
the controller is configured to receive the change of instructions in response to the headphone being connected to the connection terminal during the processed audio data is recorded to the storage medium.

9. The sound pickup device according to claim 2, further comprising:
a touch panel configured to display an instruction icon, the touch panel being disposed on the display unit, wherein
the controller is configured to control the touch panel to receive the change of instructions via the instruction icon.

10. The sound pickup device according to claim 9, wherein
the controller is configured to control the display unit to display the instruction icon and to display an input sensitivity display icon that indicates the input sensitivity that is currently set.

11. The sound pickup device according to claim 9, wherein
the controller is configured to stop displaying the instruction icon on the display unit if the change of instructions are not received within a specific length of time.

12. A method of using a sound pickup device comprising:
picking up sound with a microphone that produces audio data;
connecting a headphone to a connection terminal;
providing a controller with an input sensitivity setting mode that manages the input sensitivity of the microphone; and
receiving a change of instructions in the controller that relate to the input sensitivity of the microphone in response to the headphone being connected to the connection terminal.

13. The method of claim 12, further comprising:
capturing a subject image with an imaging unit that produces image data;
receiving instructions in a reception unit that direct the reception unit to record the image data and the audio data to a storage medium; and
displaying an image on a display unit, the image corresponding to the image data.

14. The method of claim 13, wherein
the receiving of the change of instructions includes the controller controlling the display unit to display an audio level icon that indicates the volume of the audio data when the controller is set to the input sensitivity setting mode and to not display the audio level icon when the image data is recorded to the storage medium.

15. The method of claim 14, further comprising:
providing the controller with an imaging mode that permits recording of the image data and the audio data to the storage medium in response to instructions received by the reception unit, the audio level icon not being displayed on the display unit if the controller is set to the imaging mode.

16. The method of claim 15, wherein
the receiving of the change of instructions includes the controller controlling the display unit to display an instruction icon.

17. The method of claim 16, further comprising:
providing a touch panel on the display unit, the receiving of the change of instructions includes receiving the change of instructions via the touch panel.

18. The method of claim 17, wherein
the displaying of the image includes the controller controlling the display unit to display the instruction icon and an input sensitivity display icon that indicates the input sensitivity that is currently set.

19. The sound pickup device according to claim 18, wherein
the controller stops displaying the instruction icon on the display unit if the change of instructions are not received within a specific length of time.
